(19) United States
(12) Patent Application Publication
(10) Pub. No.: US 2007/0276808 A1
(43) Pub. Date: Nov. 29, 2007

(54) URL Embedded Product Identifications Means and Method

(76) Inventor: Kevin David McGushion, Simi Valley, CA (US)

Correspondence Address: AARON MCGUSHION, 16470 HARBOUR LANE, HUNTINGTON BEACH, CA, 92649, US

(21) Appl. No.: 11/746,469

(22) Filed: May 9, 2007

Related U.S. Application Data
(60) Provisional application No. 60/746,881, filed on May 9, 2006.

(51) Int. Cl. G06F 17/30

(52) U.S. Cl. 707/3

(57) ABSTRACT

In accordance with the present invention, a linking identification code for a component or a system of components is provided comprising: a linkage code, the linkage code comprising at least an encoded URL address for linking the scanned identification to a resource located on a network, the resource containing a dataset associated with the component or the system of components. A tag code, the tag code indicating that the linking identification code contains the encoded URL address, the tag code launching the software means upon the input of the linking identification code to a client computing means, the software means being configured to retrieve data from the resource, the software means being directed to the resource, the dataset on the resource being communicated via a display means.

### CROSS-REFERENCE TO RELATED APPLICATIONS

This application is entitled to the benefit of Provisional Application for Patent Ser. No. 60/746,881 filed on May 9, 2006.

### BACKGROUND OF THE INVENTION

The present invention relates generally to product and part identification, and more particularly, to scannable identifiers having an embedded connection to a uniform resource locator (URL), identifying the resource and how to locate it.

It is of critical importance, in modern manufacturing processes, distribution chains, retail establishments, and in end use, to ensure traceability of products, and the materials and parts comprising the products. Traceability is often achieved through the use of identifiers, either generic or unique. Individual items can be traced throughout the lifespan of the product, tracking quality and inventory data, as well as being used to track and respond to demand. These identifiers can also be used to identify and track parts in components assembled at a site separate from the manufacturing site, as often happens in the construction, aerospace, semiconductor, process industries, and others. Identifiers can be used by manufacturers, distributors, end users, or any other entity in the usage chain. Identifiers can be used to reference documentation, tracking serial numbers, material IDs, date codes, test data, performance information, inspection data, inventory, finance information, and numerous additional data.

A great many manufacturing processes use identifiers to track quality, inventory, assembly, service, and recycling of products, and the components comprising the product. Identifiers can be in the form of optical identifiers such as barcodes, inductive transmitting/receiving devices, or other form of ID memory, alpha-numeric codes, and other identification technologies. The identification can be inscribed on the part or product, stamped, embedded, etched, or a tag identification means can be attached. The identification means being appropriate for the product type and expected usage environment.

An identifier can simply be a part number stamped directly on the product, assigned by the manufacturer of that product, without consultation with other entities as to the format of the part number. Often these part numbers are cryptic and difficult to read by the end user. For example, if the end user would like to replace a part within a system or reorder a product, the person would look at the part number associated with the part, figure out whom to call to reorder, and possibly compare it to other similar replacement products if the current part is no longer available. If the person is very familiar with the product line, this might not be a difficult task. However, as often is the case, the person is not familiar with the product line; and the part identification, if in a human readable format, does not immediately provide useful and direct information about the specifications of the item and ordering information. Additionally, if manufacturer generated part numbers are used, there is no system in place to prevent part number duplication across product lines made by different manufacturers, causing confusion at reorder.

Continuing with the previous example, the person finds the part number and the manufacturer's name. The next step would be to look up the part in a catalog or on-line, at the manufacturers or retailers site. Then, the person must search within the site for the specific page on the product of interest, using an internal or external search engine or links and site maps developed within the site. If successful, a product page will be displayed, having specifications, ordering information, and similar available to the person. Often, the customer will be directed to contact a distributor in the area for purchasing, adding one more step to ordering the part. As on-line purchasing becomes increasingly more popular and necessary, a refined internet-based process becomes critical as well.

If the person wishes to save, share, or communicate the product webpage, the resulting webpage address can be long and complex. When going through the trouble of ordering a part the first time, the customer may wish to record the ordering information for easy access in the future. For instance, looking at a GE product (MC550 Silicon Molding Compound), the resulting product web page address is:
http://www.gesilicones.com/NASApp/gesilecomm/SQuickDataSheet?Product=MC550B K1&Pole=3&wCase=1

The address is long, complex, and difficult to transmit and communicate. When typing the address, mistakes are easily made. Other web addresses can be even longer and more complex, not using accessible language in the address. As web addresses approach paragraph length, they are often truncated or the hyperlink broken when being transmitted or saved for future reference. Additionally, these addresses can be volatile, having changed location when revisiting at a later date, requiring an additional search to relocate the source information.

A remedy to this complex form of resource address is being used widely on the internet by portal companies such as tinyurl.com, makeashorterlink.com, and others. This involves a customer entering a complex address into, for instance, the tinyurl.com website; a simple address is generated comprised of a short sequence of characters that follow the portal address, such as http://www.tinyurl.com/dkxcu in place of the GE product address above. This address can then be transmitted easily. After activating the link, the customer's browser is directed to the tinyurl.com site, and momentarily redirects the browser to the complex address associated with the simple address. The “http://www.tinyurl.com” part of the URL directs the browser to the tinyurl.com website. The “dkxcu” will, correlated to the complex URL, will redirect the browser to the complex address. Because these systems are open for all to use and the end site is veiled from the customer, many spammers and malicious hackers abuse these sites, sending out unsolicited advertisements, scams, and virulent wares.

Another disadvantage is that the complex address must first be known by one party, and then transmitted to a second party, requiring unlikely and often unreliable cooperation between a person who needs information and the person who has the information. Additionally, the system is purely digital or virtual, with no real connection to real products or services (not being printed permanently on a product, document, and such; and it is more often used not as a product resource linking took, but rather an informational linking tool, distributing interesting news stories or videos, and such). A further disadvantage is the temporary nature of the portal generated links. There is not guarantee that the links with be “alive” or active months or years from the time of creation. Due to the shear mass of requests for simple links, the codes will need to be purged and reused for new resource addresses.

For retail products, of course, there is a universal system of product identification currently, called the universal product code (UPC). UPC codes are generally made for retail products, purchased by the end user, not for the parts used in manufacturing consumer or industrial products. The UPC bar code is usually comprised of 12 characters or decimal digits, the first digit being a prefix code and the last digit, complementary to the first, is an error correcting digit. The code follows a strict series of guidelines set forth by a GS1 member organization. For instance, the prefix “3” is reserved for pharmaceutical products and prescriptions, wherein the prefix “4” is reserved for general storewide products. Blocks of UPC codes are assigned to manufactures for their retail products, to identify them at the retail level.

When scanned at the retail level, the product ID is retrieved and a correlating price is issued along with a product name, size, and not much more. The UPC code has a practical lifespan starting from the time that all of the individual components are brought together in the finished and packaged product to the point of sell at the retail level. The UPC code essentially does not exist before the time of final packaging; and the UPC code is relatively useless in the hands of the customer after the retail sell. So, the total lifespan of the UPC code is relatively short, compared to the total lifespan of the product. This would not be acceptable in modern manufacturing and industrial applications, requiring information be linked to each part throughout its usage lifespan and possibly into its recycling and disposal.

U.S. Pat. No. 6,542,933 B1 to Durst Jr. et al. discloses a method for utilizing the UPC codes on consumer product packages to connect the end user or curious shopper to a product page, giving that shopper information regarding the scanned product. The customer inputs the existing UPC codes to a computing means (computer, phone, etc. using manual entry or a scanning means) and the computer is directed to a URL of the primary content through a routing server. The routing server supports the mapping between the respective data elements of the UPC symbols and the web site.

The original UPC code, however was not designed with the internet in mind, and does not have the URL of the desired web page encoded into it, or does it have part of the code that would trigger an internet browsing means in itself. Additionally, the UPC system is used primarily in retail stores, practically limiting '933 to those applications, not being convenient for, used by, or widely accepted by manufacturers of components, industrial equipment, and the like. They often use an internally generated coding system, useful only within the company itself. Further, once the product is purchased and the package is discarded, the UPC information is lost, not serving as a future reference.

What is needed is a universal coding system, in the form of an identification, for all stages of a products lifespan, from manufacturing to the end user, and finally, to recycling or disposal. What is further needed is a universal coding system that permanently connects the product or parts within the product with a resource on a network, the network resource remaining static for the lifespan of the product. What is also needed is a readable identification that will, upon the input into a computing means will direct the software to the resource on a network. What is also needed is a universal coding system that can be used to trace the history of the product or part, showing the specifications, chain of custody, manufacturing techniques and processes, product usage dates, and other required information.

### SUMMARY OF THE INVENTION

In accordance with the present invention, a linking identification code means for a component or a system of components is provided comprising: a linkage code, the linkage code comprising at least an encoded URL (uniform resource locator) address for linking the scanned identification to a resource located on a network, the resource containing a dataset associated with the component or the system of components; and a tag code, the tag code indicating that the linking identification code means contains the encoded URL address, the tag code launching the software means upon the input of the linking identification code means to a client computing means, the software means being configured to retrieve data from the resource, the software means being directed to the resource, the dataset on the resource having the ability to be communicated via a display means or used in with other means.

The linking identification code can further comprise: a portal code, the portal code being correlated to a portal resource, the portal code directing the software means to the portal resource; and an end resource code, the portal resource being comprised of at least an index of associations between the end resource code and the resource, the linkage code being received by the portal resource, the end resource code being correlated with an associated end resource, the software means being redirected to the end resource, the end resource being communicated via the display means.

A method for use of a linking identification code for a component or a system of components comprising the steps of: inputting into a computing means a linking identification code means comprising a linkage code and a tag code; decoding said linkage code and said tag code; launching a software means upon the decoding of said tag code, said software means being configured to retrieve a dataset from a resource; correlating said linkage code with said resource, said resource containing said dataset associated with said component or said system of components; retrieving said dataset from said resource.

### BRIEF DESCRIPTION OF THE DRAWINGS

FIG. 1 is an illustration of one possible embodiment of the present invention, showing a variation of the linking identification code.

FIG. 2 is a diagram showing one potential means for using the linking identification code of the present invention.

FIG. 3 is an illustration of one possible embodiment of the present invention, showing a variation of the linking identification code.

FIG. 4 is an illustration of a part number coded into ASCII barcode.

FIG. 5 is an illustration of a complex resource (URL) address coded into ASCII barcode.

FIG. 6 is an illustration of an embodiment of the present invention, using a simple code correlated to the complex resource code.

FIG. 7 is a example of the present invention utilized in an assembly drawing bill of materials.

FIG. 8 is a flow chart showing a method for use of a linking identification code.

### DESCRIPTION OF THE PREFERRED EMBODIMENTS

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

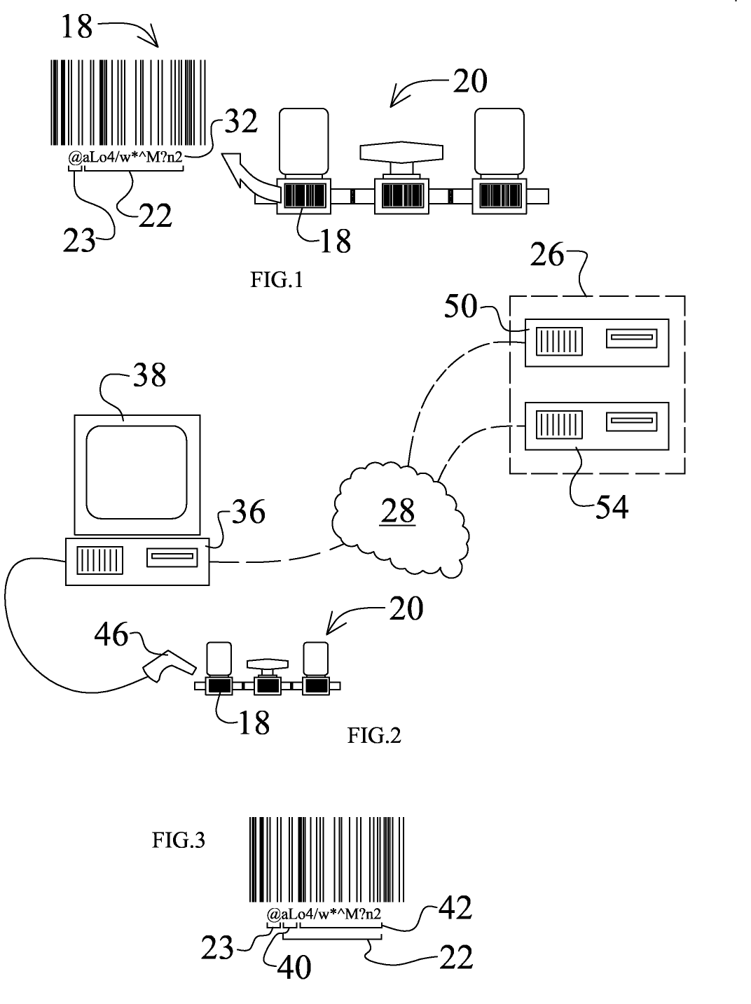

Looking at FIGS. 1 and 2, a linking identification code (18) for a component or a system of components (20) comprising: a linkage code (22), the linkage code (22) comprising at least an encoded URL address for linking the scanned identification to a resource (26) located on a network (28), the resource (26) containing a dataset associated with the component or the system of components (20); and a tag code (23), the tag code (23) indicating that the linking identification code (18) contains the encoded URL address, the tag code (23) launching the software means upon the input of the linking identification code means to a computing means (26), the software means being configured to retrieve data from the resource (26), the software means being directed to the resource (26), the dataset on the resource (26) being communicated via a display means (38).

Looking again at FIG. 1, an example of the linking identification code (18) can be seen, using a UPC-like coding sequence, generated from the alphanumeric coding (32) printed below. In this case, the code can either be scanned by a scanning means (46), which includes any device that permits the reading of the linking identification code (18) and transference of the information to a computing means (36), or the code can be read by a person and manually entered into the computing means (36). The linking identification code (18) can be in the form of optical identifiers such as barcodes, inductive transmitting/receiving devices, or other form of ID memory, alpha-numeric codes, and other identification technologies.

The linkage code (22) and the tag code (23) can be generated in numerous ways, with the tag code (23) appearing in any part of the linking identification code (18), providing that the tag code (23) can be processed and recognized as such by the computing means (36). Upon the entry of the data of the decoded linking identification code (18) into the computing means (36), a software means can be used to execute the instructions related to that tag code (23). The software means can launch a browsing program (such as Internet Explorer, Opera, FireFox, etc.) or any other programs that are designed to retrieve a dataset from a network (28) and display the dataset on the display means (38) of a computing means (36).

The tag code (23) in FIG. 1, is the at-symbol “@”. This is one example of a potential tag code (23), although many other alphanumeric options are available. In a preferred embodiment, the tag code (23) would be in a predetermined location within the linking identification code (18), for instance the first position, so that upon the reading of the sequence, the software means would recognize the inputted code as a URL enable code, being able to direct a connection to a resource (26) on a network (28). The alphanumeric symbol used as a tag code (23) may or may not be used in other locations within the linking identification code (18). If used in another location, other than the programmed tag code (23) location, the symbol will not be treated as a tag code (23).

The linkage code (22) can be generated in many ways, including random generation, sequential generation, intelligent groupings of industries, usages, and the like, or hybrids of the part number and previously mentioned generation techniques. The linkage code in any case represents a data address or URL for a resource (26) on a network (28). This resource (26) can include data stored on servers within an intranet system or internet system, accessible through a web page, ftp site, or similar. The

In FIGS. 5 and 6, a long string resource (26) address on a network (28) is associated with a generated short string series of unique characters (56), comprising the steps of: generating a linkage code (22), the linkage code (22) having at least the short string series of unique characters (56); associating the short string series of unique characters (56) with a long string product resource address (58) on the network (28); creating an index of short string series and long string product resource address associations; storing the association within a portal resource (50) such as a redirecting site server means. When the linking identification code (18) is scanned by a scanning means (46) and is decoded, the short string series of unique characters (56) directs a browsing means on the computing means (36) towards the redirecting site. The redirecting site looks up the identification input in the index and compares the short string series of unique characters (56) with the associated long string product resource address (58). The redirecting site redirects the browsing means towards the associated long string product resource address, the product resource page being displayed on the computer monitor. The tag code (23) can additionally be attached to the generated the short string series of unique characters (56).

The original long string product resource address (58), common to many websites, is much too long to be represented in common coding languages, such as ASCII. For instance, the following internet address contains information for a Textron Camtainer Fastener (part number 395-8150-00):
http://www.textronfasteningsystems.com/PDFs/catalog/ccamtainr.pdf

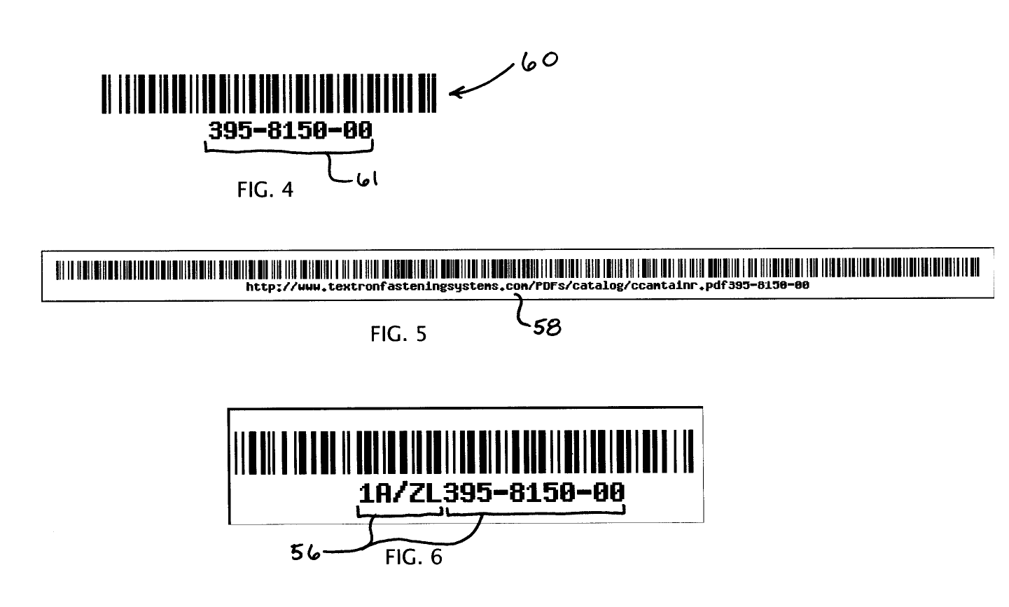

The internet address is 65 characters long. If this address were to be directly converted to ASCII barcode, as seen in FIG. 5, the resulting barcode would be far too large to actually fit on many products, particularly, in this case, a fastener. FIG. 4 shows a standard UPC code (60), with just the manufacturers internal part number (61) coded into the barcode format.

Instead, the present invention provides a means for uniquely associating a long string product resource address (58) with a short string series of unique characters (56), as demonstrated in FIG. 6. For example the long string product resource address (58):
http://www.textronfasteningsystems.com/PDFs/catalog/ccamtainr.pdf
   is converted, by either a sequentially, randomly, or intelligently generated a short string series of unique characters (56):
   1A/ZL

The short string series is embedded into the product identifier, either being the entire identification by itself or being in addition to the existing product identification (as shown in FIG. 6). The resulting much shorter UPC can be easily placed on a product or part. Scanning the part not only reveals the product part number, but also automatically directs the connected browsing means to the specific web resource page that is directly associated with that particular part or product. From that page any necessary electronic resources can be made available to the user.

Referring to FIGS. 2 and 3, The linking identification code (18) wherein the linkage code (22) can further comprise: a portal code (23), the portal code (23) being correlated to a portal resource (50), the portal code (23) directing the software means to the portal resource (50); and an end resource code (42), the portal resource (50) being comprised of at least an index of associations between the end resource code (42) and the end resource (54), the linkage code (22) being received by the portal resource (50), the end resource code (42) being correlated with the end resource (54), the software means being redirected to the end resource (54), the end resource (54) being communicated via the display means (38).

A portal resource (50), such as a gateway site is provided. The gateway site receives decoded linking identification code (18) data from the software means and redirects the software means to the end resource (54) page that is directly associated with that product.

Numerous products from different manufacturers can be indexed within the redirecting portal resource (50) site. Either existing product identifications or generated short string series of unique characters (56) can be associated with their particular manufacturers or resellers web page for that product. Many trillions of combinations of linking identification codes (18) and end resource (54) (product resource pages) associations are possible within this system, depending on the number of characters in a string.

Any participating manufacturer or interested party can participate by registering their product line and associating each linking identification codes (18) with a specific end resource (54) page located on the internet. Numerous manufacturers can have numerous linking identification codes (18) pointing towards the same redirecting gateway portal resource (50). More than one portal resource (50) site can exist if necessary.

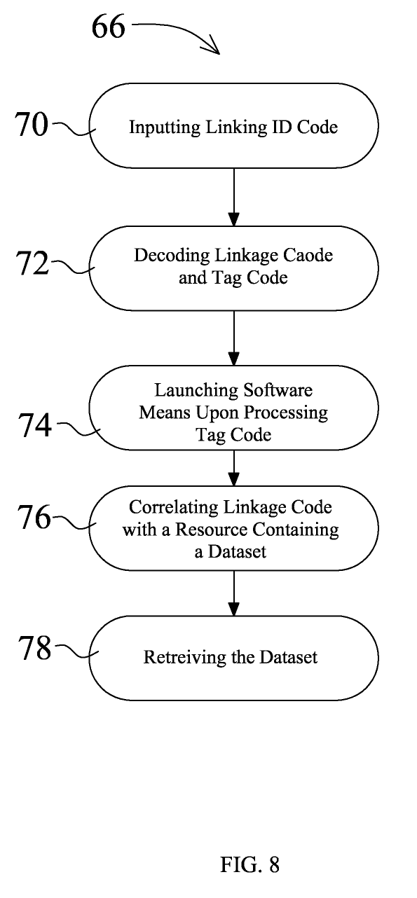

FIG. 8 shows a method (66) for use of a linking identification code (18) for a component or a system of components (20) comprising the steps of: inputting into a computing means (36) a linking identification code (18) comprising a linkage code (22) and a tag code (23) (step 70); decoding said linkage code (22) and said tag code (23) (step 72); launching a software means upon the decoding of said tag code (23), said software means being configured to retrieve a dataset from a resource (26) (step 74); correlating said linkage code (22) with said resource (26), said resource (26) containing said dataset associated with said component or said system of components (20) (step 76); retrieving said dataset from said resource (26) (step 78).

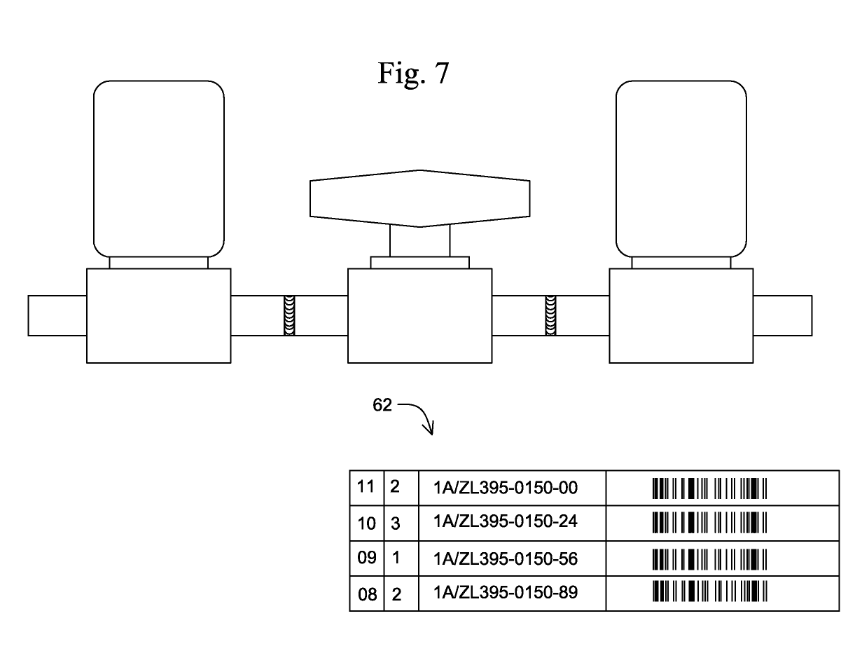

In accordance with yet another aspect of the present invention shown in FIG. 7, a URL enabled bill of materials is provided. The bill of materials (62) is inserted or associated with a product assembly drawing (64), design, documents, or similar. The URL enabled bill of materials (62) being comprised of a linking identification code (18), the linking identification code (18) being machine readable. Wherein, the linking identification code (18) within the bill of materials (62) can be indicated through a user interface (such as clicking with a mouse or similar) or scanned with a scanning means (in a printed or on-screen version), the linking identification code (18) having information directing the browsing means to a resource (26) page associated with that particular product.

Essentially, if the design drawing is printed on paper, each part indicated on the bill of materials (62) can be scanned by a scanning means (46). The associated resource (26) page is called up within the browsing means. From that page, the part can be automatically ordered based on the quantity indicated on the bill of materials, installation and usage instructions can be conveyed, and any other information or electronic resources necessary in design or assembly can be conveyed to the user.

If the design is displayed within a CAD system or design viewing means a hyperlink can be embedded within the product identification, wherein clicking or otherwise indicating the region of the barcode or product identification will direct the browsing means to the product resource page of that particular product.

If a person using the part desires information regarding the part, for ordering, reordering, specifications, and such, the person needs merely to scan the part identifier to be directed to a website or network resource that contains specific information regarding the part or product. This information can include a product description and details, ordering information (area distributors or retailers), customized features, a CAD drawing (2D or solid model), safety or recall information, optically readable identifiers that can be downloaded and inserted into drawings, documents, part bins, and such, and any other resource or information that is able to be transmitted via a network.

While the present invention has been described with regards to particular embodiments, it is recognized that additional variations of the present invention may be devised without departing from the inventive concept.

Having thus described the invention, it is now claimed:

1) A linking identification code for a component or a system of components comprising:
a linkage code, said linkage code comprising at least an encoded URL address for linking the scanned identification to a resource located on a network, said resource containing a dataset associated with said component or said system of components;
a tag code, said tag code indicating that said linking identification code contains said encoded URL address, said tag code launching said software means upon the input of said linking identification code to a computing means, said software means being configured to retrieve data from the resource, said software means being directed to said resource.

2) The linking identification code of claim 1 wherein said linkage code further comprises:
a portal code, said portal code being correlated to a portal resource, said portal code directing said software means to said portal resource;
an end resource code, said portal resource being comprised of at least an index of associations between said end resource code and an end resource, said linkage code being received by said portal resource, said end resource code being correlated with said end resource, said software means being redirected to said end resource, said end resource being communicated via said display means.

3) The linking identification code of claim 2 wherein said tag code at least serves as said portal code.

4) The linking identification code of claim 1 wherein said dataset is a component specification, said component specification containing at least a general component description.

5) The linking identification code of claim 4 wherein said component specification contains at least a specific component description, said specific component description being uniquely associated with said component or said system of components.

6) The linking identification code of claim 5 wherein said specific component description is a manufacturing record dataset, said manufacturing record dataset having information related to a manufacturing history of said component or said system of components.

7) The linking identification code of claim 5 wherein said specific component description is a quality dataset, said quality dataset having information related to a quality history of said component or said system of components.

8) The linking identification code of claim 5 wherein said specific component description is a chain of custody dataset, said chain of custody dataset having information related to a custody history of said component or said system of components.

9) The linking identification code of claim 1 wherein said dataset is a CAD block, said CAD block being insertable into CAD compatible software when said CAD block has been retrieved from said resource.

10) The linking identification code of claim 1 wherein said dataset is a component alert document, said component alert document being updatable as necessary, said component alert document comprising contemporary data regarding said component.

11) The linking identification code of claim 1 wherein said dataset is a readable code sequence block, said readable code sequence block being insertable into a drawing or a document, at least one of said readable code sequence block forming a bill of materials for a component assembly plan.

12) The linking identification code of claim 1 wherein said dataset is a purchasing means, said purchasing means facilitating at least in part the purchase of said component or said system of components.

13) The linking identification code of claim 1 wherein at least a portion of said readable code sequence is a simple code sequence, said simple code sequence corresponding to a complex code sequence, said complex code sequence being an encoded URL resource.

14) The linking identification code of claim 1 wherein said dataset on said resource being communicated to a user via a display means.

15) A method for use of a linking identification code for a component or a system of components comprising the steps of:
a) inputting into a computing means a linking identification code means comprising a linkage code and a tag code;
b) decoding said linkage code and said tag code;
c) launching a software means upon the processing of said tag code, said software means being configured to retrieve a dataset from a resource;
d) correlating said linkage code with said resource, said resource containing said dataset associated with said component or said system of components;
e) retrieving said dataset from said resource.
